(19) United States
(12) Patent Application Publication
(10) Pub. No.: US 2024/0149396 A1
(43) Pub. Date: May 9, 2024

(54) ABRASIVE IDENTIFIERS AND ASSOCIATED SYSTEMS AND METHODS FOR DETERMINING INFORMATION ABOUT ABRASIVES IN LIQUID JET CUTTING SYSTEMS

(71) Applicant: OMAX Corporation, Kent, WA (US)

(72) Inventors: Axel H. Henning, Black Diamond, WA (US); Clifford Darrow, Lyme, NH (US); Ernst H. Schubert, Snoqualmie Pass, WA (US); Guy Best, Bethel, VT (US); Martin Midura, Enfield, NH (US); Madhura Mitra, Lebanon, NH (US); Sanjay Garg, Hanover, NH (US)

(21) Appl. No.: 18/505,853

(22) Filed: Nov. 9, 2023

Related U.S. Application Data
(60) Provisional application No. 63/424,076, filed on Nov. 9, 2022.

(51) Int. Cl. B24C 7/00; B24C 1/04

(52) U.S. Cl. CPC B24C 7/0015; B24C 1/045

(57) ABSTRACT

A high-pressure liquid jet cutting system can include a hopper configured to contain an abrasive mixture that includes abrasive and an additive, and a cutting head configured to receive the abrasive mixture from the hopper and introduce the abrasive mixture into a high-pressure liquid jet. The system can further include a sensor configured to detect a characteristic of the abrasive mixture associated with the additive, and one or more processors operably connected to the sensor and configured to determine information about the abrasive based, at least in part, on the detected characteristic. The one or more processors can be configured to adjust or otherwise control operation of one or more components of the high-pressure liquid jet cutting system based, at least in part, on the information to, e.g., improve or optimize system performance.

### CROSS-REFERENCE TO RELATED APPLICATION(S)

The present application claims priority to U.S. Provisional Patent Application No. 63/424,076, filed Nov. 9, 2022, the entirety of which is incorporated by reference herein.

### TECHNICAL FIELD

The present technology is generally directed toward liquid jet cutting systems and abrasives for use with same, and associated systems and methods.

### BACKGROUND

Liquid jet cutting systems are used in precision cutting, shaping, carving, reaming, and other material processing applications. During operation of a liquid jet system, a cutting head directs a high-velocity jet of liquid carrying particles of abrasive material toward a workpiece to rapidly erode portions of the workpiece. The abrasive material can increase the cutting power and/or performance of the liquid jet system. Liquid jet processing offers advantages over other material processing technologies (e.g., grinding, plasma-cutting, etc.). For example, liquid jet systems tend to produce relatively fine and clean cuts without heat-affected zones around the cuts. Liquid jet systems also tend to be highly versatile with respect to the material type of the workpiece. The range of materials that can be processed using liquid jet systems includes very soft materials (e.g., rubber, foam, leather, paper, and even food), hard materials (e.g., steel, aluminum, titanium) as well as very hard materials (e.g., stone, ceramic, and hardened metal). Furthermore, in many cases, liquid jet systems are capable of executing demanding material processing operations while generating little or no dust, smoke, or other potentially toxic airborne byproducts.

Typically, the abrasive material added to the liquid jet is some form of garnet which is mined and processed before being supplied to an end user. There are many different suppliers of abrasive materials and the materials can have a number of different properties (e.g., particle size (such as mesh size) particle size distribution, shape, purity, density, hardness, friability, brand type, etc.) that may alter the cutting power and/or performance of the liquid jet system. Different batches and/or brands of abrasive provided by different suppliers can have different properties. This variation in properties can affect cutting outcomes and/or the overall performance of a liquid jet system.

Some liquid jet systems recycle abrasive material, leading to abrasives of multiple different types, sizes, ages, etc. being combined together and/or used at the same time. Used abrasives are often worn down due to impacts with the workpiece, etc., in the cutting process (e.g., individual particles may chip and/or shatter), which can produce different cutting outcomes as compared to new abrasives.

### BRIEF DESCRIPTION OF THE DRAWINGS

FIG. 1A is a perspective and partially schematic view of a liquid jet cutting system having an abrasive detection system configured in accordance with embodiments of the present technology.

FIG. 1B is a schematic diagram of the liquid jet cutting system of FIG. 1A illustrating aspects of the abrasive detection system configured in accordance with embodiments of the present technology.

FIG. 2 is a perspective view of an abrasive hopper of the liquid jet cutting system of FIG. 1A configured in accordance with embodiments of the present technology.

FIG. 3 is a top view of a portion of a feed tube of the liquid jet cutting system of FIG. 1A configured in accordance with embodiments of the present technology.

FIG. 4 is a chart showing measured capacitance for various types of abrasive, in accordance with embodiments of the present technology.

FIG. 5 is a graph showing a relationship between a weight percentage of an additive in an abrasive and a normalized capacitive signal of the abrasive mixture, in accordance with embodiments of the present technology.

FIGS. 6A and 6B are flow diagrams of routines for determining information about abrasives in liquid jet cutting systems, in accordance with embodiments of the present technology.

### DETAILED DESCRIPTION

The following disclosure describes various embodiments of abrasive identifiers and associated systems and methods for determining information about abrasives in liquid jet cutting systems. Because of the effect of abrasive properties on cutting outcomes and/or liquid jet system performance, it can be beneficial for users to know the properties of the abrasive material used in the liquid jet system so that the user can account for the effects caused by these properties. To help identify abrasives and their properties, some suppliers add labels, bar codes, or RFID chips to the abrasive packaging. While this approach can provide information about the abrasive, it is also easily circumvented by counterfeiting the packaging or repackaging abrasive from one supplier into another supplier's packaging, both of which can lead to substandard system performance and/or other operational issues. Moreover, once a bulk abrasive is removed from its packaging, it is very difficult to verify the brand, performance characteristics, batch, and/or other properties (e.g., for quality assurance purposes) of the abrasive. This identification becomes even more difficult if the abrasive is being recycled and reused. For example, some companies will collect used abrasive and mix it with newer batches for use in a system and/or resale. While this process can extend the lifetime of the used abrasive, it can also create issues with identifying the type of abrasive, the consistency of the abrasive, etc., and may ultimately lead to reduced system performance.

Embodiments of abrasive identification systems configured in accordance with the present disclosure can include an abrasive mixture including an abrasive and an additive. The abrasive alone can have a first characteristic, such as a first capacitance, and the addition of the additive to the abrasive can give the resulting abrasive mixture a second characteristic, such as a second capacitance, influenced by and/or otherwise associated with the additive. The second characteristic of the abrasive mixture can be detected by one or more sensors (e.g., one or more capacitive sensors) positioned at one or more locations throughout the liquid jet cutting system. For example, the liquid jet cutting system can include a hopper configured to contain the abrasive mixture and a cutting head configured to receive the abrasive mixture from the hopper and introduce the abrasive mixture into a high-pressure liquid jet. The hopper can receive the abrasive mixture at a first location, the cutting head can introduce the abrasive mixture into the high-pressure liquid jet at a second location, and the one or more sensors can be positioned at various locations between the first location and the second location.

The liquid jet cutting system can further include one or more processors operably connected to the one or more sensors and configured to determine information about the abrasive in the abrasive mixture based, at least in part, on the detected second characteristic associated with the additive. In other embodiments, the one or more sensors can be configured to detect one or more characteristics associated with the abrasive itself, and the one or more processors can use the one or more characteristics to determine information about the abrasive. In at least some of these embodiments, the additive can be omitted. As described below, a liquid jet cutting system can perform one or more actions based, at least in part, on the information determined about the abrasive. For example, the liquid jet cutting system can be configured to tune or otherwise adjust the operation of one or more components of the liquid jet cutting system (e.g., pressure(s), feed rate, cutting head motion, etc.) based, at least in part, on the information determined about the abrasive to, e.g., optimize, or at least improve, the operation of the one or more components and/or the liquid jet cutting system.

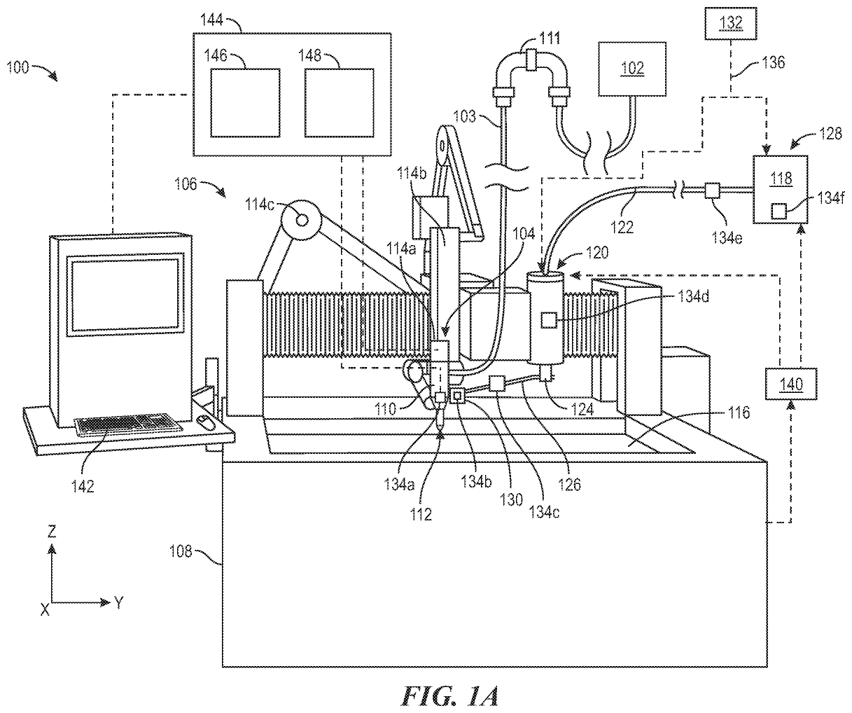

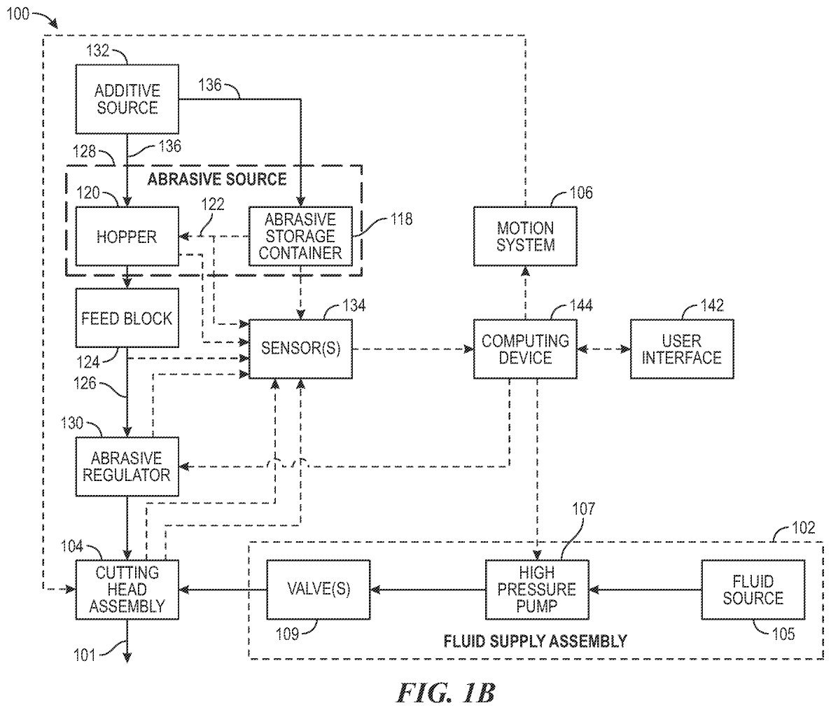

Some specific details of liquid jet systems, abrasive mixtures, additives, sensors, and associated devices, systems, and methods configured in accordance with several embodiments of the present technology are disclosed herein with reference to FIGS. 1A-6B. Although the devices, systems, and methods may be disclosed herein primarily or entirely with respect to certain liquid jet cutting applications, other applications in addition to those disclosed herein are within the scope of the present technology. Furthermore, devices, systems, and methods configured in accordance with embodiments of the present technology can have different and/or additional configurations, components, and/or procedures than those disclosed herein. Moreover, a person of ordinary skill in the art will understand that devices, systems, and methods configured in accordance with embodiments of the present technology may omit one or more of the configurations, components, and/or procedures disclosed herein without deviating from the present technology. Liquid jet systems configured in accordance with embodiments of the present technology can be used with a variety of suitable fluids, such as water, aqueous solutions, hydrocarbons, glycols, and nitrogen, and/or a variety of suitable abrasives, such as particulate abrasive, abrasive garnet, sand, and/or other appropriate abrasive materials or combinations thereof.

As used herein, the use of relative terminology, such as “about”, “approximately”, “substantially” and the like refer to the stated value plus or minus ten percent, unless the corresponding text requires otherwise. For example, the use of the term “about 100” refers to a range of from 90 to 110, inclusive. In instances in which the context requires otherwise and/or relative terminology is used in reference to something that does not include a numerical value, the terms are given their ordinary meaning to one skilled in the art.

FIG. 1A is a perspective and partially schematic view of a liquid jet cutting system 100 (“system 100”) configured in accordance with embodiments of the present technology. FIG. 1B is a schematic diagram illustrating various abrasive detection features of the system 100. Referring to FIGS. 1A and 1B together, the system 100 can include a fluid supply assembly 102 (shown schematically), a cutting head assembly 104, and a motion system 106, individual ones of which can be supported by and/or otherwise coupled to a base 108. The fluid supply assembly 102 can be configured to provide pressurized fluid to the system 100 and can include, for example, a fluid source or container 105, a pump 107 (e.g., a high-pressure pump), one or more valves 109 (FIG. 1B; shown schematically), and/or an intensifier (e.g., a Hypertherm Echion and/or HyPrecision intensifier pump), an accumulator, one or more hydraulic units, etc. (not shown). The cutting head assembly 104 can be operably connected to the fluid supply assembly 102 by, e.g., one or more conduits 103. In some embodiments, individual ones of the one or more conduits 103 include one or more joints 111 (e.g., a swivel joint or another suitable joint having two or more degrees of freedom).

The cutting head assembly 104 can include a cutting head 110 and a nozzle outlet 112. The cutting head 110 can be configured to receive liquid from the fluid supply assembly 102 via the conduit 103 at a pressure suitable for liquid jet (e.g., waterjet) processing. The pressure can be up to 5,000 psi, 10,000 psi, 15,000 psi, 55,000 psi, 60,000 psi, 120,000 psi, or greater. The cutting head 110 can include one or more components configured to condition the liquid from the fluid supply assembly 102 to, e.g., generate a liquid jet from the nozzle outlet 112. In at least some embodiments, the cutting head assembly 104 (e.g., the cutting head 110) can be configured to direct the pressurized jet of liquid toward a workpiece (not shown) supported by the base 108 to process (e.g., cut) the workpiece. In some embodiments, the system 100 can include multiple cutting heads 110 that can be controlled individually and can have the same or different parameters (orifice size, mixing tube size, abrasive size, abrasive type, abrasive feed rate, etc.). In various embodiments, the cutting head assembly 104 is configured to use various fluids including, e.g., liquid (e.g., water), and/or gases to process the workpiece, and the fluid supply assembly 102 is configured to supply these and/or other fluids to the cutting head assembly 104.

The motion system 106 can include one or more actuators configured to tilt, rotate, translate, and/or otherwise move the cutting head assembly 104. For example, in some embodiments the system 100 can include a first actuator 114a, a second actuator 114b, and a third actuator 114c (FIG. 1A; collectively, “the actuators 114”) configured to move the cutting head assembly 104 relative to the base 108 and other stationary components of the system 100, e.g., along, relative to, and/or about X-, Y-, and/or Z-axes. The actuators 114 can include, but are not limited to, gantry actuators, bridge actuators, multi-axis kinematic actuators (at least generally similar or identical in structure and/or function to OMAX Tilt-A-Jet or A-Jet tools), 6-axis robots, rotary actuators, and/or hexapod style machines. Accordingly, the actuators 114 can be configured in various ways to position the cutting head assembly 104 to allow perpendicular, rotational, and/or angular cutting of workpieces of different shapes. For example, the second actuator 114b can be configured to move the cutting head assembly 104 along a processing path (e.g., cutting path) in two or three dimensions and/or tilt the cutting head assembly 104 relative to the base 108. In these and/or other embodiments, one or more of the actuators 114 can be configured to move the base 108 relative to the cutting head assembly 104 (such as a stationary liquid jet assembly). In some embodiments, one or more of the actuators 114 can be configured to translate and/or rotate the workpiece. Accordingly, in at least some embodiments, the cutting head 110 can cut at any angle relative to the workpiece.

The base 108 can include and/or be configured to receive a cutting table 116 configured to support the workpiece relative to (e.g., beneath) the cutting head assembly 104 for, e.g., processing. The base 108 can include a diffusing tray positioned beneath the cutting table 116. The diffusing tray can be configured to hold a pool of fluid positioned relative to the cutting table 116 so as to diffuse the remaining energy of the jet from the cutting head assembly 104 after the jet passes through the workpiece.

The system 100 can further include an abrasive storage container 118 configured to hold one or more abrasive materials, such as particulate abrasive, abrasive garnet, sand, and/or other appropriate abrasive materials or combinations thereof (referred to collectively as “abrasive”). In some embodiments, the abrasive storage container 118 can be configured to provide abrasive to a hopper 120 via an abrasive conduit 122. In other embodiments, the hopper 120 can be configured to receive abrasive from one or more other sources (e.g., directly from a user, recycled abrasive via a recycling assembly 140, etc.) and the abrasive storage container 118 and/or the abrasive conduit 122 can be omitted. The abrasive contained by the hopper 120 and/or the abrasive storage container 118 can be dry or wet (e.g., slurry) via the addition of liquid.

The hopper 120 can be configured to provide abrasive contained therein to a feed block 124. The feed block 124 can be configured to provide abrasive received from the hopper 120 to the cutting head assembly 104 via, e.g., via a feed tube 126 connected between the feed block 124 and the cutting head assembly 104. The cutting head assembly 104 (e.g., the cutting head 110) can be configured to introduce the received abrasive into a liquid jet and expel the resulting abrasive-liquid jet 101 (FIG. 1B) from the nozzle 112 to, e.g., process the workpiece. Accordingly, in some embodiments the hopper 120, the abrasive storage container 118, and/or the abrasive conduit 122 can together comprise an abrasive source 128 configured to provide abrasive to the cutting head assembly 104 via the feed block 124. In some embodiments all, or at least a subset, of the abrasive source 128 is configured to move with the cutting head assembly 104 relative to, e.g., the base 108. For example, the system 100 can include a carriage movably coupled to a gantry or bridge. The gantry or bridge can be operably coupled to the base 108, e.g., at opposing and/or spaced apart ends of the gantry or bridge. The carriage can include the hopper 120 and the cutting head assembly 104. One or more of the actuators 114 can be configured to move the carriage along the gantry relative to the base 108. In other embodiments, all, or at least a subset, of the abrasive source 128 is configured to be stationary while the cutting head assembly 104 moves relative to the base 108.

In some embodiments, the system 100 includes an abrasive regulator or metering device 130 (e.g., one or more values, orifices, etc.; shown schematically) configured to control a flow of abrasive and/or other material from, e.g., the hopper 120 to and/or into the cutting head assembly 104. Although illustrated as being positioned on a downstream end of the feed tube 126 in FIG. 1A, in other embodiments the abrasive regulator 130 can be positioned at other suitable locations, e.g., proximate the feed block 124, and/or integrated into the feed block 124 and/or the cutting head assembly 104.

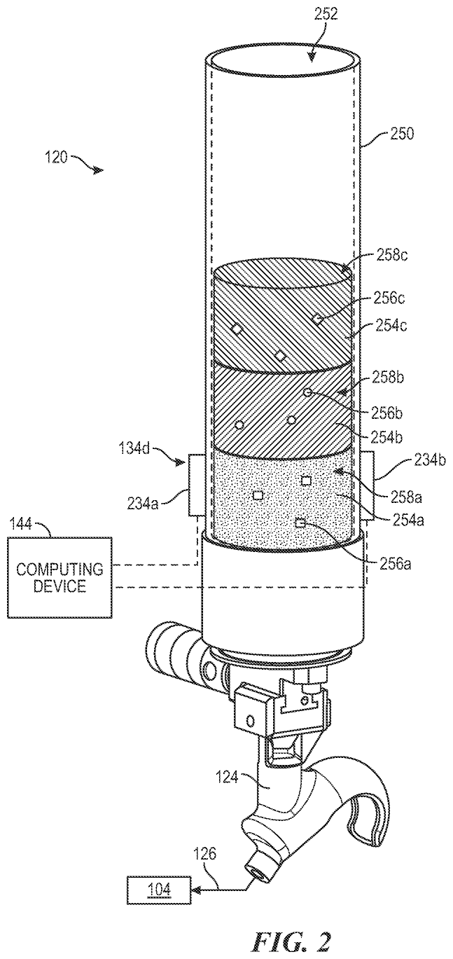

In some embodiments the system 100 can further include an additive source 132 and one or more sensors 134 (identified individually as a first sensor 134a, a second sensor 134b, a third sensor 134c, a fourth sensor 134d, a fifth sensor 134e, and a sixth sensor 134f in FIG. 1A). The additive source 132 can be configured to contain an additive (described in more detail below with reference to FIG. 2) and to introduce the additive into abrasive contained within the abrasive source 128 via, e.g., one or more additive feed lines 136 (shown schematically). In the illustrated embodiment, for example, the additive feed lines 136 are configured to introduce additive into abrasive contained within the abrasive storage container 118 and/or the hopper 120. In these and/or other embodiments, the additive feed lines 136 can be configured to introduce additive into one or more other suitable locations within the system 100 such as, for example, the fluid supply assembly 102, the cutting head assembly 104, the abrasive conduit 122, the feed block 124, the feed tube 126, the metering device 130, etc. Introducing the additive into the abrasive contained within, e.g., the hopper 120 can form an abrasive mixture or composition within the hopper that includes the abrasive and the additive. In some embodiments, the abrasive mixture is formed (e.g., by mixing the abrasive and the additive) before being introduced into the system 100 (via, e.g., the abrasive storage container, hopper 120, etc.). For example, a supplier can supply a pre-mixed abrasive mixture including abrasive and additive, and/or a user can mix abrasive with an additive before adding the resulting abrasive mixture to, e.g., the hopper 120.

The sensors 134 can be configured to detect one or more characteristics or properties of and/or associated with the abrasive, the additive, and/or the abrasive mixture. By way of nonlimiting example, the detected characteristics can include capacitance, color, magnetism, light transmission, light transmittance, luminescence (e.g., fluorescence, phosphorescence, chemiluminescence, bioluminescence, electroluminescence) at one or more light wavelengths (e.g., ultraviolet, visible, infra-red, etc.), emissivity, texture, particle size, volumetric density, a radioactive decay signature, and/or one or more other detectable properties. As described in greater detail below with reference to FIG. 2, the abrasive can have a first characteristic (e.g., a first value of a characteristic) and the additive can have a second characteristic (e.g., a second value of the characteristic) such that, when mixed together to form the abrasive mixture, the abrasive mixture can have a third characteristic (e.g., a third value of the characteristic) based, at least in part, on the first characteristic of and/or otherwise associated with the abrasive and the second characteristic of and/or otherwise associated with the additive. Additional details regarding additives can be found in David Zhang, COVERT IR OPTICAL TAGGANTS ENHANCE IDENTIFICATION, PHOTONICS MEDIA (2014), the entirety of which is hereby incorporated by reference. In some embodiments, one or more of the sensors 134 can be configured to detect the second characteristics of and/or otherwise associated with the additive and/or the third characteristic of and/or otherwise associated with the abrasive mixture. In other embodiments, the additive is omitted and one or more of the sensors 134 can be configured to detect the first characteristic of and/or otherwise associated with the abrasive.

The sensors 134 can be positioned at various locations throughout the system 100. In some embodiments, one or more of the sensors 134 can be positioned between the abrasive storage container 118 and the nozzle 112. For example, as shown in FIG. 1A, the first sensor 134a can be operably coupled to (e.g., mounted on or positioned at least partially within) the cutting head 110 or the nozzle 112 to, e.g., detect the one or more characteristics of the abrasive, the additive, and/or the abrasive mixture moving through the cutting head assembly 104. The second sensor 134b can be operably coupled to (e.g., mounted on or positioned at least partially within) the abrasive regulator 130 to, e.g., detect the one or more characteristics of/associated with the abrasive, the additive, and/or the abrasive mixture moving through the abrasive regulator 130. The third sensor 134c can be operably coupled to (e.g., mounted on or positioned at least partially within) the feed tube 126 to, e.g., detect the one or more characteristics of/associated with the abrasive, the additive, and/or the abrasive mixture moving through the feed tube 126. The fourth sensor 134d can be operably coupled to (e.g., mounted on or positioned at least partially within) the hopper 120 to, e.g., detect the one or more characteristics of/associated with the abrasive, the additive, and/or the abrasive mixture contained within the hopper 120. The fifth sensor 134e can be operably coupled to (e.g., mounted on or positioned at least partially within) the abrasive conduit 122 to, e.g., detect the one or more characteristics of/associated with the abrasive, the additive, and/or the abrasive mixture within the abrasive conduit 122. The sixth sensor 134f can be operably coupled to (e.g., mounted on or positioned at least partially within) the abrasive storage container 118 to, e.g., detect the one or more characteristics of/associated with the abrasive, the additive, and/or the abrasive mixture contained within the abrasive storage container 118. One or more of the sensors 134 can be part of the system 100 as originally designed and/or manufactured, and/or one or more of the sensors 134 can be added (e.g., retrofitted) to the system 100 at some time after its manufacture.

In some embodiments, the system 100 includes a recycling assembly 140 (FIG. 1A). The recycling assembly 140 can be configured to receive liquid (e.g., water), abrasive, and/or additive discharged from the nozzle 112 and collected within the base 108. For example, the system 100 can include a pump and a conveyance (e.g., a conduit, tubing, etc.) operably coupled to the recycling assembly 140. The pump can be configured to flow liquid, abrasive, and/or additive from the base 108 to the recycling assembly 140 via the conveyance. In some embodiments, the recycling assembly 140 can include a dehydration device including, e.g., one or more dehumidifiers, desiccants, heating elements, and/or other devices configured to remove all, or at least a portion, of the water from the received abrasive and/or additive. In some embodiments, the recycling assembly 140 can include a fines separator and/or other waste filtering device configured to remove all, or at least a portion of, the workpiece fines and kerf material, spent abrasive, spent additive, and/or other waste particles contained within the received abrasive and/or additive. Once water and/or waste particles have been at least partially removed, the recycling assembly 140 can return the reclaimed abrasive and/or the reclaimed additive to the abrasive source 128 (via, e.g., the hopper 120, the abrasive storage container 118, etc.) for, e.g., continued use in processing the workpiece. The reclaimed abrasive can include dry abrasive or an abrasive slurry (e.g., water and abrasive). Recycling the abrasive and/or the additive can increase the useable lifetime of these materials and thereby reduce the cost of operating the system 100. Additional details regarding abrasive recycling systems can be found in U.S. Pat. No. 11,577,366, filed Dec. 12, 2017, and titled “RECIRCULATION OF WET ABRASIVE MATERIAL IN ABRASIVE WATERJET SYSTEMS AND RELATED TECHNOLOGY,” the entirety of which is incorporated by reference herein. It will be appreciated that the abrasive recycling techniques described in the above-identified patent can also be used to recycle one or more of the additives and/or the abrasive mixtures described herein.

In some embodiments, the system 100 further includes a user interface 142 configured to receive input from a user and/or to send data based, e.g., on the input to a computing device 144 (e.g., a controller). The user interface 142 can include a mobile phone, a tablet, a laptop computer, a desktop computer, a display screen, and/or one or more other suitable user interface devices. The received input can include, for example, one or more specifications (e.g., coordinates, geometry or dimensions) of the processing path and/or one or more specifications (e.g., material type or thickness) of the workpiece and operating parameters (e.g., for a liquid jet tool, pressure, flow rate, abrasive material, etc.). The computing device 144 (shown schematically) can be operably connected to the user interface 142, one or more of the actuators 114 (e.g., via one or more wired connections (e.g., electrical cables), wireless connections (e.g., Bluetooth connections, WiFi, etc.), and/or one or more of the sensors 134 (e.g., via one or more electrical cables, wireless connections, etc.; shown schematically and only for the first sensor 134a). The computing device 144 can be coupled to the base 108 and/or positioned in a same room as the base 108, or can be positioned remotely from the base 108, e.g., in a different room, building, city, zip code, state, country, continent, etc. In some embodiments, the system 100 can include one or more computing devices with at least one of the computing devices positioned remotely from the base 108. Although not shown in FIGS. 1A and 1B, in some embodiments the system 100 can include one or more power-receiving devices (e.g., power cords) and/or other power sources (e.g., one or more batteries, generators, etc.) configured to provide power to one or more components of the system.

The computing device 144 can include one or more processors 146 and one or more non-transitory, computer-readable media 148 (e.g., computer memory) that can be programmed with instructions (e.g., non-transitory, computer-executable instructions contained on a non-transitory computer-readable medium) that, when executed by the one or more processors 146, control operation of the system 100. For example, in at least some embodiments the computing device 144 can be configured to adjust or otherwise control operation of one or more other components of the system 100 (e.g., the fluid supply assembly 102, the cutting head assembly 104, the motion system 106, the abrasive regulator 130 etc.) based, at least in part, on data from one or more of the sensors 134.

For example, as shown in FIG. 1B, in some embodiments data from the sensors 134 relating to one or more characteristics of an abrasive, an additive, and/or an abrasive/additive mixture can be provided to the computing device 144 which, in turn, can determine information about the abrasive, the additive, and/or the mixture based on the data. The computing device 144 can then perform one or more actions based, at least in part, on the determined information, including sending instructions to adjust the operation of, e.g., the motion system 106, the fluid supply assembly 102 (e.g., the high pressure pump 107), the abrasive regulator 130, and/or one or more other components of the system 100. The actions can include automatically and/or dynamically calibrating one or more cutting parameters (e.g., abrasive index, cut speed, flow rate, pump pressure, etc.), stopping the system 100, sending a signal or other message (e.g., text message on a mobile device, printing a message on the operator screen, etc.) to the user; signaling or otherwise prompting a sales action (e.g., abrasive auto-replenishment, providing a purchase recommendation, etc.), signaling or otherwise prompting a warranty action, providing manufacturing data to an external system (e.g., accurate abrasive cost per job, number of uses left per batch of abrasive, etc.), and/or one or more other suitable actions. In some embodiments, one or more of these actions are performed in response to an input from a user. For example, the system 100 can display or otherwise present, via the user interface 142, the information determined about the abrasive to the user to allow the user to make changes to the operation of the system 100 to, e.g., adjust for various properties of the abrasive and thereby achieve improved, or even optimized, performance. Additionally, or alternatively, the computing device 144 can perform one or more of these actions, including adjusting the operation of the system 100, automatically (e.g., without user input) based, at least in part, on the data received from the sensors 134.

In some embodiments, data from the sensors 134 can be used to provide information to abrasive suppliers about the abrasive materials they supply. For example, if system performance issues arise in relation to a given abrasive, data from the sensors 134 can be used to determine the batch the abrasive came from (e.g., the source of the problem). This can, in turn, allow users to report potentially faulty batches of abrasive to suppliers. Suppliers can, in turn, put specific batches of abrasive on watch or hold depending on the severity of these issues. This is expected to provide greater control and/or understanding of abrasive performance in the industry, aiding suppliers and/or users in controlling abrasive product quality.

It will be understood that embodiments of the additives, sensors, and other devices, systems, and methods configured in accordance with the present technology disclosed herein are not limited to use with the system 100, but can be used with a wide variety of other suitable systems, including other liquid jet cutting systems with one or more features additional to and/or different than the features disclosed herein. Similarly, it will be understood that the various components, features, operations, etc. of the system 100 are described herein by way of example and that, unless otherwise specified herein, all such components, features, operations, etc. are not essential to all embodiments of the present technology. For example, as described above, in some embodiments one or more of the sensors 134 can be configured to detect one or more characteristics of the abrasive and, in at least some of these embodiments, the additive source 132 and/or the corresponding additive can be omitted.

FIG. 2 is a perspective view of the hopper 120, configured in accordance with embodiments of the present technology. The hopper 120 can include one or more sidewalls 250 that define an interior space or chamber 252 configured to receive and/or contain an abrasive 254 (individually identified as a first abrasive 254a, a second abrasive 254b, and a third abrasive 254c) and/or an additive 256 (individually identified as a first additive 256a, a second additive 256b, and a third additive 256c). As used herein, “the abrasive 254” and/or other like terms refer to one or more abrasive materials, unless the context requires otherwise. As used herein, “the additive 256” and/or other like terms refers to one or more additives, unless the context requires otherwise. The abrasive 254 and the additive 256 can mix together to form an abrasive mixture or composition 258 (individually identified as first abrasive mixture or composition 258a, a second abrasive mixture or composition 258b, and a third abrasive mixture or composition 258c). For example, the first abrasive 254a and the first additive 256a can together define the first abrasive mixture 258a, the second abrasive 254b and the second additive 256b can together define the second abrasive mixture 258b, and/or the third abrasive 254c and the third additive 256c can together define the third abrasive mixture 258c. As used herein, “the abrasive mixture 258” and/or other like terms refer to one or more abrasive mixtures, unless the context requires otherwise. When the hopper 120 contains multiple abrasive mixtures 258a-c, each abrasive mixture 258a-c can be separated, or at least generally separated, from each other (as shown in FIG. 2), or mixed together. Similarly, the abrasive 254 and the additive 256 in a given abrasive mixture 258 can be mixed together or separated from one another. Although the additives 256a-c are depicted as large particles in FIG. 2 for purposes of illustration, it will be understood that the additives 256a-c can mix with the corresponding abrasives 254a-c to, e.g., form a homogenous mixture, a heterogeneous mixture, or a partially homogenous/heterogeneous mixture. Although the hopper 120 is illustrated as having a cylindrical shape in FIG. 2, in other embodiments the hopper can have an oval, triangular, square, rectangular, etc. cross-section. The sidewalls 250, or at least a portion of the sidewalls 250, can be transparent, at least partially transparent, or opaque to, e.g., visible light, infrared light, ultraviolet light, radio waves, electrical signals, magnetic fields, microwaves, radiation, etc., to allow the sensor 134d to detect the characteristic(s) of the abrasive 254, the additive 256, and/or the abrasive mixture 258 contained within the hopper 120.

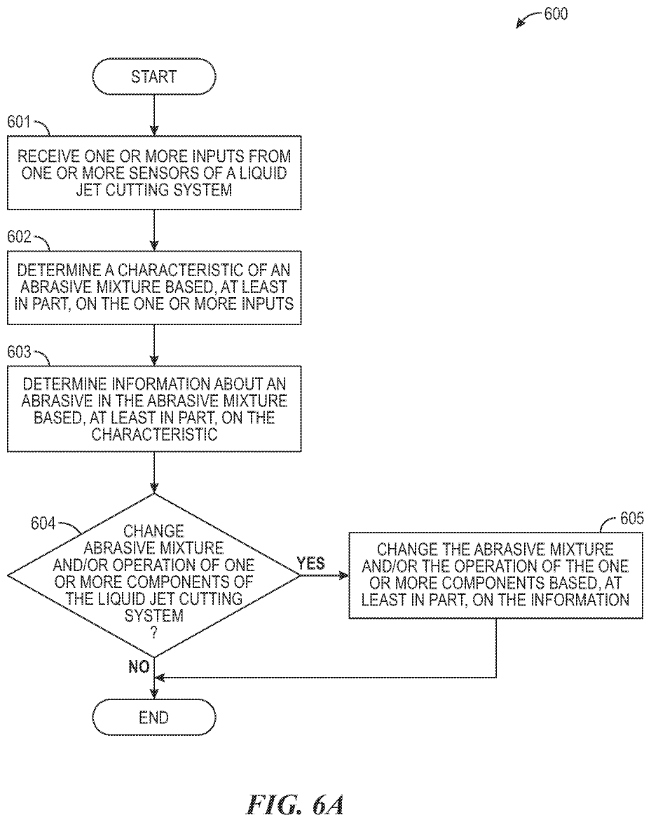

The abrasive 254 can include one or more suitable abrasive materials, such as garnet, sand, crushed rock, mined alluvial deposits, and/or other suitable abrasive materials or combinations thereof known in the art. The additive 256 (which can also be referred to, e.g., as a taggant, abrasive identifier, or the like) can include one or more materials detectable by the sensors 134 and, in at least some embodiments, can include one or more elements, compounds, materials, etc. that are not typically present in the abrasive 254. For example, the additive 256 can include one or more of a polymer, a metal, a ceramic material, a natural colloidal material, and/or other suitable materials. In one embodiment described in detail below with reference to FIG. 5, the additive 256 includes metallic particles, such as steel grit. In these and/or other embodiments, the additive 256 can include other materials such as aluminum, titanium and/or other hard and/or durable metals (e.g., tungsten, iridium, steel, osmium, chromium), mica, quantum dots, nanoparticles, alumina, oxides, carbides, etc. In some embodiments, the additive 256 includes a dye, a paint, a stain, and/or a coating applied to the abrasive 254. By way of nonlimiting examples, the additive 256 can include the Olnica® Taggant, manufactured by Olnica, headquartered in France; the ValiDotz™ taggants, manufactured by Dotz Nano Ltd., headquartered in Australia; spectroTAG® markers and/or one or more other plastoTRACE® additives, manufactured by U-NICA®, headquartered in Landquart, Switzerland; one or more taggants manufactured by BioCote® Ltd, headquartered in Coventry, United Kingdom; one or more taggants manufactured by Microtrace LLC, headquartered in Minneapolis, Minnesota; and/or one or more other suitable additives.

The sensor 134d can be positioned to detect one or more characteristics of the abrasive 254, the additive 256, and/or the corresponding abrasive mixture 258 contained within the hopper 120. In the illustrated embodiment, for example, the sensor 134d is a capacitive sensor that can include a pair of sensor elements 234a, 234b (e.g., conductive plates or electrodes 234a, 234b) mounted to the sidewalls 250 on opposing sides of the chamber 252 to detect a capacitance of the abrasive mixture 258 positioned between the pair of electrodes 234a, 234b. In other embodiments, the sensor 134d can include a photoelectric and/or other optical sensor and the sensor elements 234a, 234b can include a light source 234a configured to project light through the abrasive mixture 258 within the chamber 252 and a light receiver 234b configured to detect the light passing through the abrasive mixture 258 and thereby determine a value of or a change to a transmittance, a luminescence, and/or a reflectance of the abrasive mixture 258. In these and/or other embodiments, the sensor elements 234a, 234b of the sensor 134d can have other suitable positions, such as embedded at least partially within the sidewall 250, positioned at least partially within the chamber 252, etc. Additionally, or alternatively, the sensor 134d can include additional or fewer sensor elements, and/or one or more of the sensor elements 234a, 234b can have other configurations based, at least in part, on the characteristic of the abrasive 254, the additive 256, and/or the abrasive mixture 258 to be detected.

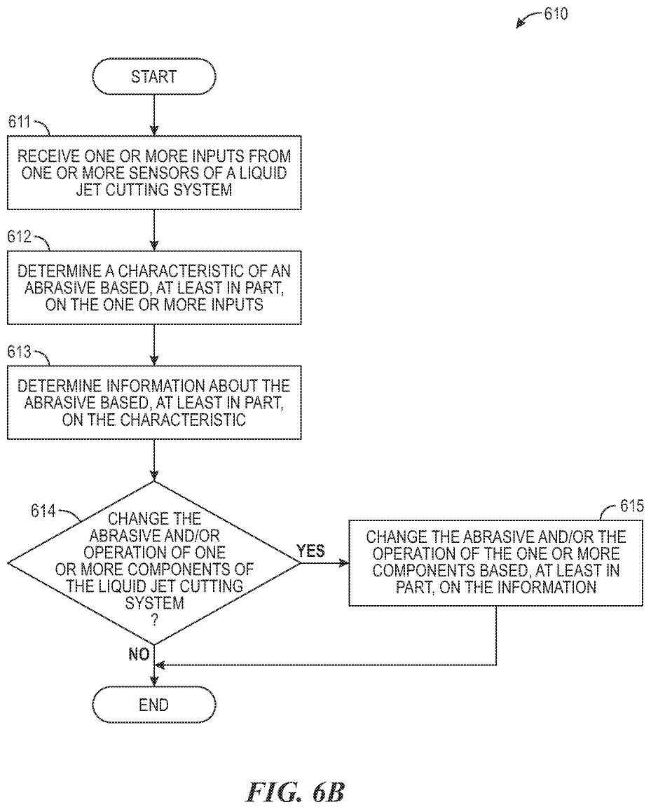

In the illustrated embodiment, the computing device 144 is configured to receive one or more inputs (e.g., signals, data, etc.) from the sensor 134d indicating and/or otherwise corresponding to the detected characteristic of the abrasive 254, the additive 256, and/or the abrasive mixture 258. The computing device 144 can be configured to determine the characteristic based on the inputs and, based at least in part on the characteristic, determine information about the abrasive 254, the additive 256, and/or the mixture 258. For example, the sensor 134d can detect a characteristic (e.g., a capacitance) of the first abrasive mixture 258a associated with the first additive 256a. The computing device 144 can determine information (e.g., age, particle size, particle size distribution, shape, purity, brand, packing density, hardness, and/or friability, etc.) about the first abrasive 254a based on the detected capacitance. For example, in some embodiments the memory 148 (FIG. 1A) can store computer readable instructions that provide an algorithm or data structure (e.g., a look-up table) that correlates the characteristic of the first abrasive mixture 258a to information about the first abrasive 254a. This is described in greater detail below with reference to FIG. 6A. When the processor 146 receives the detected characteristic via the sensor 134d, the processor 146 can execute the algorithm and/or access the data structure using the detected characteristic to determine the information about the first abrasive 254a.

In some embodiments, the sensor 134d and/or one or more of the other sensors 134 can be configured to detect a plurality of characteristics of/associated with the abrasive mixture 258. For example, the abrasive 254 can have a first characteristic (e.g., a capacitance) and the additive 256 have a second characteristic (e.g., luminescence, a color, a radioactive signature, etc.) of a type different than or distinct from the first characteristic. In such embodiments, the computing device 144 can determine first information about the abrasive 254 based on the first characteristic and second information about the abrasive 254 based on the second characteristic.

As noted above, in some embodiments the additive 256 can be omitted and/or the computing device 144 can be configured to determine information about the abrasive 254 based, at least in part, on one or more characteristics of and/or otherwise associated with the abrasive 254 itself. For example, the sensor 134d can detect a characteristic (e.g., a capacitance) of the first abrasive 254a in the hopper 120 and send a corresponding signal to the computing device 144 that provides the detected characteristic, and the computing device 144 can use the detected characteristic to determine information (e.g., age, particle size, particle size distribution, shape, purity, brand, packing density, hardness, and/or friability, etc.) about the first abrasive 254a. For example, the memory 148 (FIG. 1A) can store computer readable instructions that provide an algorithm or data structure (e.g., a look-up table) that relates the detected characteristic of/associated with the first abrasive 254a to the information about the first abrasive 254a. When the processor 145 receives the detected characteristic via the sensor 134d, the processor 146 can execute the algorithm and/or access the data structure using the detected characteristic to determine the information about the first abrasive 254a. This is described in greater detail below with reference to FIG. 6B.

As shown in FIG. 2, multiple different batches of abrasive mixtures 258a-c can be contained within the hopper 120. The hopper 120 can receive the multiple batches at the same time or in sequence, e.g., the second abrasive mixture 258b after the first abrasive mixture 258a, the third abrasive mixture 258c after the second abrasive mixture 258b, etc. For example, an amount of the first abrasive mixture 258a can be added to the hopper 120 at a first time and, at a second time after the first time, such as when the amount of the first abrasive mixture 258a has dropped to a certain level, the second abrasive mixture 258b can be added to the hopper 120. The third abrasive mixture 258c can be added to the hopper 120 at a third time after the second time, such as when the amount of the first and/or second abrasive mixture 258a, 258b within the hopper 120 is low. Additionally or alternatively, the abrasive mixture 258 can be recycled by the recycling assembly 140 (FIG. 1A) and reintroduced into the hopper 120 to mix with any abrasive mixture 258 contained therein. Accordingly, in at least some embodiments, multiple different abrasive mixtures 258a-c can be contained within the hopper 120 and/or otherwise in circulation within the system 100 at any given time.

In some embodiments, the computing device 144 can use data from the sensor 134d, and/or one or more of the other sensors 134 described herein, to determine an amount of each abrasive mixture 258 contained within the hopper 120 and/or otherwise in circulation within the system 100 at a given time. For example, when multiple abrasives 254a-c, multiple additives 256a-c, and/or multiple abrasive mixtures 258a-c are present, the characteristics of individual ones of the abrasives 254a-c can be different than the characteristics of one or more of the other abrasives 254a-c, the characteristics of individual ones of the additives 256a-c can be different than the characteristics of one or more of the other additives 256a-c, and/or the characteristics of individual ones of the abrasive mixtures 258a-c can be different than the characteristics of one or more of the other abrasive mixtures 258a-c. These differences can help distinguish between the various abrasives 254a-c, additives 256a-c, and/or abrasive mixtures 258a-c in use within the system. The sensor 134d and/or one or more of the other sensors 134 (FIGS. 1A and 1B) can be configured to detect the characteristics of the individual abrasives 254a-c, the individual additives 256a-c, and/or the individual abrasive mixtures 258a-c to, e.g., determine the information noted above about the abrasives 254a-c in each of the abrasive mixtures 258a-c. For example, if the additives 256a-c have a same wear rate as the corresponding abrasives 254a-c, the sensor 134d can be used to detect a change in the characteristics associated with the additives 256a-c to determine a corresponding change in the amount of the related abrasive 254a-c.

In some embodiments, the additive 256 are configured to provide information about the abrasive 254 (as described above) but otherwise remain inert during the cutting process. In other embodiments, in addition to helping determine information about the abrasive 254, the additive 256 can be configured to improve the cutting process by, e.g., increasing the cut rate of the liquid jet 101 (FIG. 1B), reducing static charge buildup of the abrasive mixture 258 (e.g., by a portion of the additive 256 including mica), spacing abrasive granules during use and/or storage (e.g., to reduce or prevent clumping, maintain the consistency of the abrasive mixture, etc.), decreasing clogging in one or more components of the liquid jet cutting system, changing an impact profile of the abrasive 254, decreasing wear of one or more components of the liquid jet cutting system, acting as a dry lubricant, etc.

In some embodiments, the additive 256 wears (e.g., fracture or fail) at the same rate, or at least substantially the same rate, as the abrasive 254, and can thus be recycled at the same (or a substantially similar) rate as the abrasive. In other embodiments, the additive 256 wears at a rate slower than the abrasive 254 and can be used to track abrasive mixing over time. For example, the slower wear rate of the additive 256 means that, when the additive 256 and the abrasive 254 are mixed into other abrasives and/or abrasive mixtures, the additive 256 can outlast the abrasive 254 and thus indicate that the abrasive 254 was mixed into one or more other abrasives and/or abrasive mixtures after the abrasive 254 is fully spent or otherwise no longer detectable (e.g., by the sensors 134). The additive 256 can be fluid-soluble (e.g., water soluble) and mix with the liquid in the system 100 or can be fluid-insoluble (e.g., not water soluble) and form a suspension within the liquid in the system 100. In some embodiments, the additive 256 can be configured to dissolve, decompose, or otherwise be destroyed when exposed to a predetermined temperature (e.g., a temperature greater than 50° F., 60° F., 70° F., 80° F., and/or less than 100° F., 150° F., 200° F., etc.) and/or a predetermined pressure (e.g., a pressure greater than 40,000 psi, 55,000 psi, 60,000 psi, 100,000 psi, and/or less than 120,000 psi, 150,000 psi, etc.) In other embodiments, the additive 256 can be configured to withstand, resist degradation, and/or other wear at temperatures of up to 100° F., 150° F., 200° F., etc. and/or at pressures of up to 40,000 psi, 55,000 psi, 60,000 psi, 100,000 psi, 120,000 psi, 150,000 psi, etc.

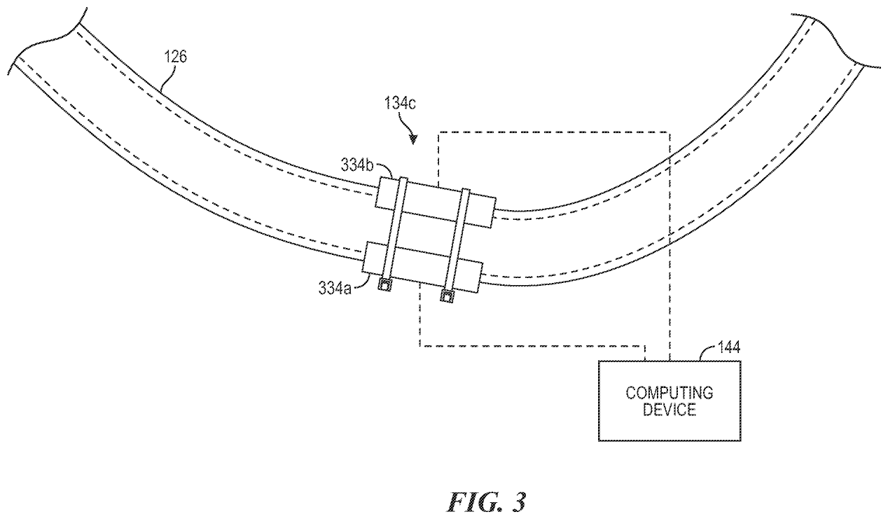

FIG. 3 is a top view of a portion of the feed tube 126 configured in accordance with embodiments of the present technology. As described previously herein with reference to FIGS. 1A and 2, the sensor 142b can be positioned on the feed tube 126 to detect one or more characteristics of the abrasives, the additives, and/or the abrasive mixtures moving through the feed tube 126 toward the hopper 120 (FIG. 1A). In the illustrated embodiment, the sensor 134c is a capacitive sensor having a pair of conductive electrodes 334a, 334b positioned at least partially around the feed tube 126. In these and/or other embodiments, rather than a capacitive sensor, the sensor 134c could also be one or more of the other sensors described herein and/or any other suitable sensor, such as a photoelectric and/or other optical sensor. The sensor 134c can be communicatively coupled to the computing device (via, e.g., one or more wires, a wireless communication connection, etc.) and can be at least generally similar or identical in structure and/or function to the sensor 134d described in detail above with reference to FIG. 2. As described previously herein, it will be appreciated that the feed tube 126 and the hopper 120 (FIGS. 1A-2) are representative sensor placement locations and that, in these and/or other embodiments, the sensor 134c and/or one or more of the other sensors described herein can be positioned at other locations, such as between the hopper 120 and cutting head assembly 104 and/or at least partially within the cutting head assembly 104.

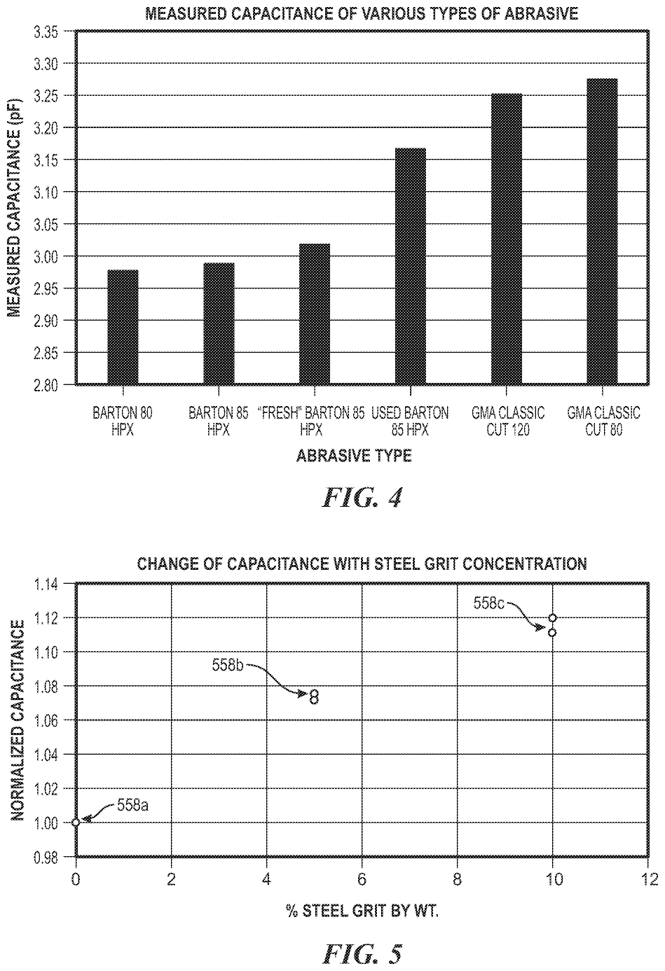

FIG. 4 is a graph (e.g., a histogram) showing measured capacitance (in picofarads) for various types of abrasive, in accordance with embodiments of the present technology. In this embodiment, each type of abrasive includes a brand name (e.g., “Barton HPX®,” “GMA ClassicCut®”) and a mesh size (e.g., “80,” “85,” “120”). Different brands and/or mesh sizes of abrasive can have different material compositions and, accordingly, are expected to have one or more different detectable characteristics. For example, as shown in FIG. 4, Barton 80 HPX abrasive has a lower capacitance compared to Barton 85 HPX abrasive, and both Barton 80 HPX and Barton 85 HPX have a lower capacitance than GMA ClassicCut 80 abrasive, with the difference between Barton and GMA branded abrasives being greater than the difference between different mesh sizes of Barton abrasives or between different mesh sizes of GMA abrasives. Without being bound by theory, it is believed that this difference between Barton and GMA-branded abrasives is not caused by a difference in dielectric constants of the abrasive but rather by different packing densities of these two abrasive brands. For example, the Barton HPX® abrasive is crushed from rock, whereas the GMA ClassicCut® originates from mined alluvial deposits and has a different shaping and a greater proportion of fines compared to Barton HPX®. The alluvial abrasive particles in GMA ClassicCut® are also smoother than those of the crushed rock used in Barton HPX®. The different shaping and increased proportion of fines in the GMA ClassicCut® is believed to cause an increased packing density of this abrasive brand and, for a capacitive sensor of a given size, increases the amount of abrasive that can fit between the electrodes of the capacitive sensor. This, in turn, is believed to increase the measured capacitance of GMA ClassicCut® abrasive compared to Barton HPX®. Accordingly, one or more of the sensors 134 can detect these different capacitances and the processor 146 can, based at least in part on these detected capacitances, determine the brand, packing density, abrasive shape, proportion of fines, whether the abrasive includes crushed rock (such as Barton HPX®) or mined alluvial deposits (such as GMA ClassicCut® or Barton HPA®), and/or other information about the abrasive material in use, e.g., without prior knowledge about the type of abrasive added to the system. For example, the processor 146 can be configured to identify or at least estimate the brand of the abrasive based, at least in part, on the detected capacitance and use the estimated brand to determine additional information about the abrasive based on known properties associated with the brand, such as packing density, abrasive shape, etc.

The characteristics of abrasive are expected to change over time. For example, as shown in FIG. 4, used Barton 85 HPX that was collected and dried after being run through an abrasive liquid jet cutting system once has an increased capacitance compared to the other Barton HPX® abrasives. As noted above, an increase in the amount of metal fines (or other waste material) in the abrasive is expected to increase the measured capacitance of the abrasive. As abrasive is used by the system 100, the proportion of fines in the abrasive is expected to increase as, e.g., more workpiece material is cut and/or abrasive particles are fragmented or otherwise “spent” while processing the workpiece. Therefore, abrasive that is older (i.e., has been used more one or more, two or more, three or more, etc. times) is expected to have an increased capacitance compared to “newer” or unused abrasive due, at least in part, to an increased amount of fines in the older abrasive. Accordingly, the change in capacitance of abrasive within the system 100 over time can be used to determine the presence of recycled and/or used (e.g., “aged”) abrasive within the system 100. For example, an increase in the capacitance over time can indicate an increase in recycled and/or used abrasive, whereas a decrease in the capacitance can indicate the removal of recycled and/or used abrasive and/or the presence or addition of newer or unused abrasive. Additionally, or alternatively, because the capacitance increases as the amount of spent abrasive increases, the processor 146 can be configured to determine an amount of the spent abrasive and/or an amount of usable abrasive that has been recycled based, at last in part, on a detected increase in the capacitance. For example, the processor 146 can be configured to compare the detected capacitance and/or a detected change in the capacitance to a table or chart of capacitance over time for various known abrasives. If the detected capacitance (and/or change in capacitance) matches the data from the table or chart, the processor 146 use this to determine (or at least predict) the age of the abrasive.

FIG. 5 is a graph showing the relationship between a weight percentage of an additive (e.g., steel grit; measured along the horizontal axis) in an abrasive composition and the normalized capacitive signal of the abrasive composition (measured along the vertical axis), in accordance with embodiments of the present technology. Data from three different abrasive compositions 558 are shown: a first abrasive composition 558a including Barton 85 HPX abrasive and 0%-by-weight steel grit additive, a second abrasive composition 558b including Barton 85 HPX abrasive and 5%-by-weight steel grit additive, and a third abrasive composition 558c including Barton 85 HPX abrasive and 10%-by-weight steel grit additive. One measurement was obtained for the first abrasive composition 558a and two measurements were obtained for both the second and third abrasive compositions 558b, 558c. Steel grit additive used for these tests was 50-80 mesh size.

The dielectric constant of metal (including steel grit) is essentially infinite and, accordingly, small amounts of metal can be added to abrasive to change the capacitance of the resulting abrasive mixture in detectable ways. This is shown by the data in FIG. 5. Specifically, the addition of 5% or 10%-by-weight of steel grit leads to a proportional increase in capacitance of the abrasive compositions 558a-c. Thus, different concentrations of metallic particles can be used as additives to tailor the capacitive properties of abrasive mixtures, e.g., to create a more consistent capacitive signature.

FIG. 6A illustrates a flow diagram of a method or routine 600 for determining information about abrasives in liquid jet cutting systems, in accordance with embodiments of the present technology. The routine 600 is illustrated as a number of process portions, steps, or blocks 601-605. All or a subset of the blocks 601-605 can be performed by the computing device 144. For example, the memory 148 can store computer-readable instructions that, when executed by the processor 146, cause the processor 146 to perform at least some or all of the blocks 601-605 of the routine 600.

At block 601, the routine 600 receives one or more inputs (e.g., signals, data, transmissions, etc.) from one or more sensors of a liquid jet cutting system. The one or more sensors can include any of the sensors described previously herein (e.g., one or more of the sensors 134). In at least some embodiments, for example, receiving one or more inputs can include receiving one or more inputs from a capacitance sensor, an optical sensor, etc. Receiving the one or more inputs can include receiving multiple inputs (e.g., a first input, a second input, etc.) at the same time or at different times (e.g., the first input at a first time, the second input at a second time, etc.).

At block 602, the routine 600 determines a characteristic of an abrasive mixture based, at least in part, on the one or more inputs (block 601). In some embodiments, the characteristic of the abrasive mixture is associated with an additive in the abrasive mixture. For example, the abrasive mixture can include an additive and an abrasive, including any of the additives and/or abrasives described herein. In some embodiments, the characteristic is unique to the additive, such as a capacitance, color, a luminescence, a radioactive decay signal, and/or one or more other characteristics detectable by one or more sensors. In other embodiments, the abrasive includes a first characteristic (e.g., a first capacitance), the additive includes a second characteristic (e.g., a second capacitance), and the one or more inputs include one or more inputs indicating a third characteristic (e.g., a third capacitance) of the abrasive mixture resulting from the combination of the abrasive and the additive and their respective first and second characteristics. The processor 146 can be configured to receive the one or more inputs (e.g., electrical signals, optical signals, etc.) from the sensors (block 601) and interpret these inputs to determine the characteristic of the abrasive mixture. For example, the processor 146 can be configured to convert a received electrical signal into a capacitance, an electrical resistance, a wavelength of light, an amount of light, etc.

At block 603, the routine 600 determines information about an abrasive in the abrasive mixture based, at least in part, on the characteristic (block 602). By way of nonlimiting example, the information about the abrasive can include supplier, age, particle size, particle size distribution, shape, purity, brand, packing density, hardness, friability, any other information described herein, and/or other suitable information about the abrasive. In some embodiments, by accessing a data structure (e.g., a look-up table), stored in the memory 148, that correlates the characteristic (block 602) to the information about the abrasive. For example, if a known abrasive mixture includes an additive configured to luminesce at a known wavelength, this data can be input into the look-up table and used to identify the abrasive, e.g., when one or more of the sensors 134 detect the known wavelength. As another example, if the addition of an additive to an abrasive gives the resulting abrasive mixture a specific or unique capacitance, such as described previously with reference to FIG. 5, this data can be input into the look-up table and used to identify the abrasive, e.g., when one or more of the sensors 134 detect the known specific or unique capacitance.

At decision block 604, the routine 600 determines whether to change the abrasive mixture and/or the operation of one or more components of the liquid jet cutting system based on the information (block 603). For example, the processor 146 can determine that a change to the abrasive mixture and/or the operation of the one or more components would be desirable to, e.g., reduce system operating costs, improve system performance, adjust for a change in system performance related to the information about the abrasive, etc. The one or more components can include the fluid supply assembly 102, the cutting head assembly 104, the motion system 106, any sub-components thereof, and/or any other components of the system 100. If the processor 146 determines that the abrasive and/or the operation of the one or more components should not change (block 604, NO), the routine 600 can repeat one or more of the blocks 601-603 and/or end. If the processor 146 determines that a change to the abrasive and/or the operation of the one or more components would be beneficial or otherwise desirable (block 604, YES), then the routine 600 proceeds to block 605.

In one particular example, the information (block 603) can include an age of the abrasive. As described previously with reference to FIG. 4, abrasive that has been used/recycled at least once is expected to have an increased amount of fines compared to newer and/or unused abrasive. The increased amount of fines is expected to reduce a cutting power of the liquid jet cutting system. Accordingly, the processor can determine whether to change the abrasive mixture and/or the operation of one or more components of the liquid jet cutting system based, at least in part, on the age of the abrasive.

In block 605, the routine 600 can include changing the abrasive mixture and/or the operation of the one or more components based, at least in part, on the information. Changing the abrasive mixture can include removing the abrasive mixture and/or the associated abrasive from the system, adding more of the abrasive mixture and/or the associated abrasive to the system 100, adding a newer batch of the abrasive mixture and/or the associated abrasive to the system 100, and/or adding a different abrasive mixture and/or abrasive to the system 100. Adjusting the operation of one or more of the components of the liquid jet cutting system can include automatically and/or dynamically calibrating one or more cutting parameters (e.g., abrasive index, cut speed, flow rate, pump pressure, etc.), stopping the system 100, sending a signal or other message (e.g., text message on a mobile device, printing a message on the operator screen, etc.) to the user, performing any of the other actions described herein, and/or otherwise adjusting the operation of the one or more components. In some embodiments, changing the abrasive mixture and/or adjusting the operation of the one or more components can improve a performance of the liquid jet cutting system. For example, if the age of the abrasive indicates that the liquid jet cutting system has reduced cutting power, as described previously with reference to block 604, then block 605 can include adding a newer batch of the abrasive mixture (e.g., to increase the cutting power) and/or reducing a cut speed and/or rate of movement of the cutting head assembly 104, increasing a pressure of the liquid jet 101, and/or otherwise adjusting the operation of one or more components of the liquid jet cutting system to account for the reduced cutting power and/or otherwise improve the performance of the liquid jet cutting system.

FIG. 6B illustrates a flow diagram of a method or routine 610 for determining information about abrasives in liquid jet cutting systems, in accordance with embodiments of the present technology. The routine 610 is illustrated as a number of process portions, steps, or blocks 611-615. All or a subset of the blocks 611-615 can be performed by the computing device 144. For example, the memory 148 can store computer-readable instructions that, when executed by the processor 146, cause the processor 146 to perform at least some or all of the blocks 611-615 of the routine 610.

At block 611, the routine 610 receives one or more inputs indicating a characteristic of an abrasive. Block 611 can be at least generally similar or identical to block 611 of the routine 600, but the received signals can correspond to an abrasive, rather than an abrasive mixture including an abrasive and an additive.

At block 612, the routine 610 determines a characteristic of an abrasive based, at least in part, on the one or more inputs. Block 612 can be at least generally similar to block 602 of the routine 600 but, as noted above in block 611, the additive can be omitted.

At block 613, the routine 610 determines information about the abrasive based, at least in part, on the characteristic. Block 613 can be at least generally similar to block 603 of the routine 600, but can use the characteristic of the abrasive to determine information about the abrasive, rather than using a characteristic of abrasive mixture including an additive determine information about an abrasive in the abrasive mixture.

At block 614, the routine 610 determines whether to change the abrasive and/or the operation of one or more components of the liquid jet cutting system. Block 614 can be at least generally similar or identical to block 604 of the method, but can include determining whether to change the abrasive, rather than determining whether to change an abrasive mixture including an abrasive and an additive.

At block 615, the routine 610 can include changing the abrasive and/or the operation of one or more components of the liquid jet cutting system. Block 615 can be at least generally similar or identical to block 605 of the routine 600 but can include changing (e.g., removing, replacing, adding more of, etc.) the abrasive, rather than changing an abrasive mixture including an abrasive and an additive.

### EXAMPLES

Several aspects of the present technology are described with reference to the following examples:

1. A high-pressure liquid jet cutting system, the system comprising:
a hopper configured to contain an abrasive mixture received into the hopper at a first location, the abrasive mixture including abrasive and an additive;
a cutting head configured to receive the abrasive mixture from the hopper, wherein the cutting head is configured to introduce the received abrasive mixture into a high-pressure liquid jet at a second location;
a sensor positioned between the first location and the second location, wherein the sensor is configured to detect a characteristic of the abrasive mixture associated with the additive; and
one or more processors operably coupled to the sensor and configured to determine information about the abrasive in the abrasive mixture based, at least in part, on the detected characteristic of the abrasive mixture.

2. The high-pressure liquid jet cutting system of example 1 wherein the hopper includes a sidewall that defines a chamber configured to contain the abrasive mixture, and wherein the sensor is positioned on the sidewall and configured to detect the characteristic of the abrasive mixture within the chamber.

3. The high-pressure liquid jet cutting system of example 1 or 2, further comprising a feed tube positioned between the hopper and the cutting head, wherein the sensor is positioned on the feed tube and configured to detect the characteristic of the abrasive mixture moving through the feed tube.

4. The high-pressure liquid jet cutting system of any of examples 1-3 wherein the abrasive has a first value of the characteristic, wherein mixing the additive with the abrasive results in the abrasive mixture having a second value of the characteristic, and wherein the sensor is configured to detect the second value of the characteristic of the abrasive mixture.

5. The high-pressure liquid jet cutting system of example 4 wherein the characteristic is a capacitance and wherein the sensor includes a capacitive sensor.

6. The high-pressure liquid jet cutting system of example 4 or 5 wherein the characteristic includes a color and wherein the sensor includes an optical sensor.

7. The high-pressure liquid jet cutting system of any of examples 1-6 wherein the additive includes one or more of a polymer, a ceramic material, a metal, and/or a colloidal material.

8. The high-pressure liquid jet cutting system of any of examples 1-7 wherein the one or more processors are configured to determine a particle size and/or a brand of the abrasive based, at least in part, on the characteristic of the abrasive mixture.

9. The high-pressure liquid jet cutting system of any of examples 1-8 wherein the one or more processors are configured to determine a packing density, a hardness, and/or a friability, of the abrasive based, at least in part, on the characteristic of the abrasive mixture.

10. The high-pressure liquid jet cutting system of any of examples 1-9 wherein the one or more processors are configured to determine an age of the abrasive based, at least in part, on the characteristic of the abrasive mixture.

11. The high-pressure liquid jet cutting system of any of examples 1-10 wherein the characteristic of the abrasive mixture is a first characteristic detected at a first time, wherein the sensor is further configured to detect a second characteristic of the abrasive mixture associated with the additive at a second time, different than the first time, and wherein the one or more processors are configured to determine an age of the abrasive in the abrasive mixture based, at least in part, on the first characteristic of the abrasive mixture and the second characteristic of the abrasive mixture.

12. The high-pressure liquid jet cutting system of example 11 wherein the first characteristic includes a first capacitance and wherein the second characteristic includes a second capacitance.

13. The high-pressure liquid jet cutting system of any of examples 1-12 wherein
the hopper is configured to receive an amount of the abrasive mixture,
the characteristic of the abrasive mixture is a first characteristic detected at a first time,
the sensor is further configured to detect a second characteristic of the abrasive mixture at a second time, different than the first time, and
the one or more processors are configured to determine an amount of spent abrasive material within the abrasive mixture based at least in part on the first and second characteristics of the abrasive mixture.

14. The high-pressure liquid jet cutting system of example 13 wherein the first time is before the abrasive mixture is introduced into the high-pressure liquid jet, wherein the second time is after the abrasive mixture has been discharged from the cutting head in the high-pressure liquid jet.

15. The high-pressure liquid jet cutting system of example 13 or 14 wherein the first characteristic includes a first capacitance and the second characteristic includes a second capacitance.

16. The high-pressure liquid jet cutting system of any of examples 1-15 wherein—
the characteristic of the abrasive mixture is a first characteristic detected at a first time,
the abrasive mixture is a first abrasive mixture,
the hopper is configured to receive a second abrasive mixture to mix with the first abrasive mixture at a second time,
the sensor is further configured to detect a second characteristic associated with mixing the first and second abrasive mixtures after the second time, and
the one or more processors are configured to determine an amount of the first abrasive mixture recycled into the second abrasive mixture based, at least in part, on the first characteristic and the second characteristic.

17. The high-pressure liquid jet cutting system of any of examples 1-16, further comprising one or more non-transitory, computer-readable media storing a data structure that relates the detected characteristic associated with the additive to the information about the abrasive, wherein the one or more processors are configured to access the data structure using the detected characteristic associated with the additive to determine the information about the abrasive.

18. The high-pressure liquid jet cutting system of any of examples 1-17 wherein the high-pressure liquid jet cutting system is a high-pressure water jet cutting system and the high-pressure liquid jet is a high-pressure water jet.

19. A method of operating a high-pressure liquid jet cutting system, the high-pressure liquid jet cutting system having a hopper and a cutting head, the method comprising:
receiving, at a first location, an abrasive mixture into the hopper, the abrasive mixture including abrasive and an additive;
causing the abrasive mixture to flow from the hopper toward the cutting head, wherein the cutting head is configured to introduce the abrasive mixture into a high-pressure liquid jet at a second location;
detecting, via one or more sensors positioned between the first location and the second location, a characteristic of the abrasive mixture, wherein the characteristic is associated with the additive; and
determining, via one or more processors operably coupled to the one or more sensors, information about the abrasive in the abrasive mixture based, at least in part, on the detected characteristic of the abrasive mixture.

20. The method of example 19 wherein the hopper includes a sidewall that defines a chamber that contains the abrasive mixture, and wherein detecting, via the one or more sensors, a characteristic of the abrasive mixture includes detecting the characteristic through the sidewall of the hopper.

21. The method of example 19 or 20 wherein the high-pressure liquid jet cutting system further includes a feed tube configured to convey the abrasive mixture from the hopper to the cutting head, and wherein detecting, via the one or more sensors, a characteristic of the abrasive mixture includes detecting the characteristic through a sidewall of the feed tube.

22. The method of any of examples 19-21 wherein the abrasive has a first value of the characteristic, wherein mixing the additive with the abrasive results in the abrasive mixture having a second value of the characteristic, and wherein detecting the characteristic via the one or more sensors includes detecting the second value of the characteristic of the abrasive mixture.

23. The method of example 22 wherein detecting the characteristic includes detecting a capacitance associated with the additive.

24. The method of example 22 or 23 wherein detecting the characteristic includes detecting a color associated with the additive.

25. The method of any of examples 22-24 wherein detecting the characteristic includes detecting a luminescence associated with the additive.

26. The method of any of examples 19-25 wherein the additive includes one or more of a polymer, a ceramic material, a metal, and/or a colloidal material, and wherein detecting the characteristic includes detecting a characteristic associated with one or more of the polymer, the ceramic material, the metal, and/or the colloidal material.

27. The method of any of examples 19-26 wherein determining the information includes determining a mesh size and/or a brand of the abrasive.

28. The method of any of examples 19-27 wherein determining the information includes determining a packing density, a hardness, and/or a friability of the abrasive.

29. The method of any of examples 19-28 wherein determining the information includes determining an age of the abrasive.

30. The method of any of examples 19-29 wherein the characteristic is a first characteristic obtained at a first time, and wherein the method further comprises:
detecting a second characteristic at a second time, wherein determining the information includes determining an age of the abrasive in the abrasive mixture based, at least in part, on the first characteristic and the second characteristic.

31. The method of example 30 wherein the first characteristic includes a first capacitance and wherein the second characteristic includes a second capacitance.

32. The method of any of examples 19-31 wherein receiving the abrasive mixture includes receiving an amount of the abrasive mixture, wherein detecting the characteristic includes detecting a first characteristic at a first time, and wherein the method further comprises:
detecting, via the one or more sensors, a second characteristic of the abrasive mixture associated with the additive at a second time after the first time,
wherein determining the information includes determining an amount of spent abrasive material within the abrasive mixture based, at least in part, on the first characteristic and the second characteristic.

33. The method of example 32 wherein the first characteristic includes a first capacitance and the second characteristic includes a second capacitance.

34. The method of any of examples 19-33 wherein the abrasive mixture is a first abrasive mixture, wherein detecting the characteristic includes detecting a first characteristic at a first time, and wherein the method further comprises:
receiving, via the hopper and after the first time, a second abrasive mixture different than the first abrasive mixture to form a third abrasive mixture including the first abrasive mixture and the second abrasive mixture, and
detecting, via the one or more sensors, a second characteristic of the third abrasive mixture at a second time after receiving the second abrasive mixture,
wherein determining the information includes determining an amount of the first abrasive mixture recycled into the second abrasive mixture based at least in part on the first characteristic and the second characteristic.

35. The method of any of examples 19-34 wherein the high-pressure liquid jet cutting system includes one or more non-transitory, computer-readable media, and wherein determining the information includes querying, via the one or more processors, a data structure with the detected characteristic associated with the additive, the data structure stored in the one or more non-transitory, computer-readable media and relating the detected characteristic associated with the additive to the information about the abrasive.

36. The method of any of examples 19-35 wherein the high-pressure liquid jet cutting system is a high-pressure water jet cutting system and the high-pressure liquid jet is a high-pressure water jet.

37. The method of any of examples 19-36, further comprising changing the abrasive mixture and/or operation of one or more components of the high-pressure liquid jet cutting system based, at least in part, on the information.

38. The method of example 37 wherein the information includes an age of the abrasive, and wherein changing the abrasive mixture includes adding newer and/or unused abrasive to the abrasive mixture.

39. The method of example 37 or 38 wherein the abrasive in the abrasive mixture is a first abrasive, and wherein changing the abrasive mixture includes adding a second abrasive, different than the first abrasive, to the abrasive mixture.

40. The method of any of examples 37-39 wherein changing the operation of one or more components of the high-pressure liquid jet cutting system includes changing a rate of movement of the cutting head.

41. The method of any of examples 37-40 wherein the information includes an age of the abrasive, and wherein changing the operation of one or more components of the high-pressure liquid jet cutting system includes decreasing a rate of movement of the cutting head based, at least in part, on the age of the abrasive.

42. An abrasive mixture for use with a high-pressure liquid jet cutting system, the abrasive mixture comprising:
an abrasive material having a first characteristic and configured to combine with a liquid jet of the high-pressure liquid jet cutting system to process a workpiece; and
a sensor-detectable additive material mixed with the abrasive material and having a second characteristic.

43. The abrasive mixture of example 42 wherein the first characteristic includes a first capacitance and the second characteristic includes a second capacitance.

44. The abrasive mixture of example 42 or 43 wherein the first characteristic includes a first color and the second characteristic includes a second color.

45. The abrasive mixture of any of examples 42-44 wherein the second characteristic includes a luminescence.

46. The abrasive mixture of any of examples 42-45 wherein the abrasive material includes garnet.

47. The abrasive mixture of any of examples 42-46 wherein the additive material includes one or more of a polymer, a ceramic material, a metal, and/or a colloidal material.

48. The abrasive mixture of any of examples 42-47 wherein the additive material includes a dye or a coating applied to the abrasive material.

49. The abrasive mixture of any of examples 42-48 wherein the additive material is configured to withstand temperatures of up to 200° F.

50. The abrasive mixture of any of examples 42-49 wherein the additive material is configured to withstand pressures of up to 100,000 psi.

51. A high-pressure liquid jet cutting system, the system comprising:
a hopper configured to contain an abrasive received into the hopper at a first location;
a cutting head configured to receive the abrasive from the hopper, wherein the cutting head is configured to introduce the received abrasive into a high-pressure liquid jet at a second location;
a sensor positioned between the first location and the second location, wherein the sensor is configured to detect a characteristic of the abrasive; and
one or more processors operably coupled to the sensor and configured to determine information about the abrasive based, at least in part, on the detected characteristic of the abrasive.

52. The high-pressure liquid jet cutting system of example 51 wherein the hopper includes a sidewall that defines a chamber configured to contain the abrasive, and wherein the sensor is positioned on the sidewall and configured to detect the characteristic of the abrasive within the chamber.

53. The high-pressure liquid jet cutting system of example 51 or 52, further comprising a feed tube positioned between the hopper and the cutting head, wherein the sensor is positioned on the feed tube and configured to detect the characteristic of the abrasive moving through the feed tube.

54. The high-pressure liquid jet cutting system of any of examples 51-53 wherein the characteristic is a capacitance and wherein the sensor includes a capacitive sensor.

55. The high-pressure liquid jet cutting system of any of examples 51-54 wherein the characteristic includes a color and wherein the sensor includes an optical sensor.

56. The high-pressure liquid jet cutting system of any of examples 51-55 wherein the one or more processors are configured to determine a particle size and/or a brand of the abrasive based, at least in part, on the characteristic of the abrasive.

57. The high-pressure liquid jet cutting system of any of examples 51-56 wherein the one or more processors are configured to determine a packing density, a hardness, and/or a friability, of the abrasive based, at least in part, on the characteristic of the abrasive.

58. The high-pressure liquid jet cutting system of any of examples 51-57 wherein the one or more processors are configured to determine an age of the abrasive based, at least in part, on the characteristic of the abrasive.

59. The high-pressure liquid jet cutting system of any of examples 51-58 wherein the characteristic of the abrasive is a first characteristic detected at a first time, wherein the sensor is further configured to detect a second characteristic of the abrasive at a second time, different than the first time, and wherein the one or more processors are configured to determine an age of the abrasive based, at least in part, on the first characteristic of the abrasive and the second characteristic of the abrasive.

60. The high-pressure liquid jet cutting system of example 59 wherein the first characteristic includes a first capacitance and wherein the second characteristic includes a second capacitance.

61. The high-pressure liquid jet cutting system of any of examples 51-60 wherein
the hopper is configured to receive an amount of the abrasive,
the characteristic of the abrasive is a first characteristic detected at a first time,
the sensor is further configured to detect a second characteristic of the abrasive at a second time, different than the first time, and
the one or more processors are configured to determine an amount of spent abrasive material within the abrasive based at least in part on the first and second characteristics of the abrasive.

62. The high-pressure liquid jet cutting system of example 61 wherein the first time is before the abrasive is introduced into the high-pressure liquid jet, wherein the second time is after the abrasive has been discharged from the cutting head in the high-pressure liquid jet.

63. The high-pressure liquid jet cutting system of example 61 or 62 wherein the first characteristic includes a first capacitance and the second characteristic includes a second capacitance.

64. The high-pressure liquid jet cutting system of any of examples 51-63 wherein—
the characteristic of the abrasive is a first characteristic detected at a first time,
the abrasive is a first abrasive,
the hopper is configured to receive a second abrasive to mix with the first abrasive at a second time,
the sensor is further configured to detect a second characteristic associated with mixing the first and second abrasives after the second time, and
the one or more processors are configured to determine an amount of the first abrasive recycled into the second abrasive based, at least in part, on the first characteristic and the second characteristic.

65. The high-pressure liquid jet cutting system of any of examples 51-64, further comprising one or more non-transitory, computer-readable media storing a data structure that relates the detected characteristic to the information about the abrasive, wherein the one or more processors are configured to access the data structure using the detected characteristic to determine the information about the abrasive.

66. The high-pressure liquid jet cutting system of any of examples 51-65 wherein the high-pressure liquid jet cutting system is a high-pressure water jet cutting system and the high-pressure liquid jet is a high-pressure water jet.

67. A method of operating a high-pressure liquid jet cutting system, the high-pressure liquid jet cutting system having a hopper and a cutting head, the method comprising:
receiving, at a first location, an abrasive into the hopper;
causing the abrasive to flow from the hopper toward the cutting head, wherein the cutting head is configured to introduce the abrasive into a high-pressure liquid jet at a second location;
detecting, via one or more sensors positioned between the first location and the second location, a characteristic of the abrasive; and
determining, via one or more processors operably coupled to the one or more sensors, information about the abrasive in the abrasive based, at least in part, on the detected characteristic of the abrasive.

68. The method of example 67 wherein the hopper includes a sidewall that defines a chamber that contains the abrasive, and wherein detecting, via the one or more sensors, a characteristic of the abrasive includes detecting the characteristic through the sidewall of the hopper.

69. The method of example 67 or 68 wherein the high-pressure liquid jet cutting system further includes a feed tube configured to convey the abrasive from the hopper to the cutting head, and wherein detecting, via the one or more sensors, a characteristic of the abrasive includes detecting the characteristic through a sidewall of the feed tube.

70. The method of any of examples 67-69 wherein detecting the characteristic includes detecting a capacitance.

71. The method of any of examples 67-70 wherein detecting the characteristic includes detecting a color.

72. The method of any of examples 67-71 wherein detecting the characteristic includes detecting a luminescence.

73. The method of any of examples 67-72 wherein determining the information includes determining a mesh size and/or a brand of the abrasive.

74. The method of any of examples 67-73 wherein determining the information includes determining a packing density, a hardness, and/or a friability of the abrasive.

75. The method of any of examples 67-74 wherein determining the information includes determining an age of the abrasive.

76. The method of any of examples 67-75 wherein the characteristic is a first characteristic
obtained at a first time, and wherein the method further comprises:

detecting a second characteristic at a second time, wherein determining the information includes determining an age of the abrasive based, at least in part, on the first characteristic and the second characteristic.

77. The method of example 76 wherein the first characteristic includes a first capacitance and wherein the second characteristic includes a second capacitance.

78. The method of any of examples 67-77 wherein receiving the abrasive includes receiving an amount of the abrasive, wherein detecting the characteristic includes detecting a first characteristic at a first time, and wherein the method further comprises:
detecting, via the one or more sensors, a second characteristic of the abrasive at a second time after the first time,
wherein determining the information includes determining an amount of spent abrasive material within the abrasive based, at least in part, on the first characteristic and the second characteristic.

79. The method of example 78 wherein the first characteristic includes a first capacitance and the second characteristic includes a second capacitance.

80. The method of any of examples 67-79 wherein the abrasive is a first abrasive, wherein detecting the characteristic includes detecting a first characteristic at a first time, and wherein the method further comprises:
receiving, via the hopper and after the first time, a second abrasive different than the first abrasive to form a third abrasive including the first abrasive and the second abrasive, and
detecting, via the one or more sensors, a second characteristic of the third abrasive at a second time after receiving the second abrasive mixture,
wherein determining the information includes determining an amount of the first abrasive recycled into the second abrasive based at least in part on the first characteristic and the second characteristic.

81. The method of any of examples 67-80 wherein the high-pressure liquid jet cutting system includes one or more non-transitory, computer-readable media, and wherein determining the information includes accessing, via the one or more processors, a data structure with the detected characteristic, the data structure stored in the one or more non-transitory, computer-readable media and relating the detected characteristic to the information about the abrasive.

82. The method of any of examples 67-81 wherein the high-pressure liquid jet cutting system is a high-pressure water jet cutting system and the high-pressure liquid jet is a high-pressure water jet.

83. The method of any of examples 67-82, further comprising changing the abrasive and/or operation of one or more components of the high-pressure liquid jet cutting system based, at least in part, on the information.

84. The method of example 83 wherein the information includes an age of the abrasive, and wherein changing the abrasive includes adding newer and/or unused abrasive to the high-pressure liquid jet cutting system.

85. The method of example 83 or 84 wherein the abrasive is a first abrasive, and wherein changing the abrasive includes adding a second abrasive, different than the first abrasive, to the high-pressure liquid jet cutting system.

86. The method of any of examples 83-85 wherein changing the operation of one or more components of the high-pressure liquid jet cutting system includes changing a rate of movement of the cutting head.

87. The method of any of examples 83-86 wherein the information includes an age of the abrasive, and wherein changing the operation of one or more components of the high-pressure liquid jet cutting system includes decreasing a rate of movement of the cutting head based, at least in part, on the age of the abrasive.

The present disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown and/or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may have been disclosed in the context of those embodiments, other embodiments may also exhibit such advantages, and not all embodiments need necessarily exhibit such advantages or other advantages disclosed herein to fall within the scope of the present technology.

Certain aspects of the present technology may take the form of computer-executable instructions, including routines executed by the computing device 144. In some embodiments, the computing device 144 is specifically programmed, configured, or constructed to perform one or more of these computer-executable instructions. Furthermore, aspects of the present technology can be stored or distributed on tangible computer-readable media, including magnetically or optically readable computer discs, hard-wired or preprogrammed chips (e.g., EEPROM semiconductor chips), nanotechnology memory, biological memory, or other data storage media. The data storage devices can include any type of computer-readable media that can store data accessible by a computer, such as magnetic hard and floppy disk drives, optical disk drives, magnetic cassettes, tape drives, flash memory cards, DVDs, Bernoulli cartridges, RAM, ROMs, smart cards, etc. Indeed, any medium for storing or transmitting computer-readable instructions and data may be employed, including a connection port to a network such as a LAN, WAN, or the Internet. Alternatively, computer implemented instructions, data structures, screen displays, and other data under aspects of the invention can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). The terms “memory” and “computer-readable storage medium” include any combination of temporary, persistent, and/or permanent storage, e.g., ROM, writable memory such as RAM, writable non-volatile memory such as flash memory, hard drives, solid state drives, removable media, and so forth, but do not include a transitory propagating signal per se. Accordingly, data structures and transmissions of data particular to aspects of the present technology are encompassed within the scope of the present technology. The present technology also encompasses methods of both programming computer-readable media to perform particular steps and executing the steps.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like may be used herein to mean including at least the recited feature(s) such that any greater number of the same feature(s) and/or one or more additional types of features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not all referring to the same embodiment. Furthermore, various particular features, structures, operations, or characteristics may be combined in any suitable manner in one or more embodiments of the present technology.

I/We claim:

1. A high-pressure liquid jet cutting system, the system comprising:
a hopper configured to contain an abrasive mixture received into the hopper at a first location, the abrasive mixture including abrasive and an additive;
a cutting head configured to receive the abrasive mixture from the hopper, wherein the cutting head is configured to introduce the received abrasive mixture into a high-pressure liquid jet at a second location;
a sensor positioned between the first location and the second location, wherein the sensor is configured to detect a characteristic of the abrasive mixture associated with the additive; and
one or more processors operably coupled to the sensor and configured to determine information about the abrasive in the abrasive mixture based, at least in part, on the detected characteristic of the abrasive mixture.

2. The high-pressure liquid jet cutting system of claim 1 wherein the hopper includes a sidewall that defines a chamber configured to contain the abrasive mixture, and wherein the sensor is positioned on the sidewall and configured to detect the characteristic of the abrasive mixture within the chamber.

3. The high-pressure liquid jet cutting system of claim 1, further comprising a feed tube positioned between the hopper and the cutting head, wherein the sensor is positioned on the feed tube and configured to detect the characteristic of the abrasive mixture moving through the feed tube.

4. The high-pressure liquid jet cutting system of claim 1 wherein the abrasive has a first value of the characteristic, wherein mixing the additive with the abrasive results in the abrasive mixture having a second value of the characteristic, and wherein the sensor is configured to detect the second value of the characteristic of the abrasive mixture.

5. The high-pressure liquid jet cutting system of claim 4 wherein the characteristic is a capacitance and wherein the sensor includes a capacitive sensor.

6. The high-pressure liquid jet cutting system of claim 4 wherein the characteristic includes a color and wherein the sensor includes an optical sensor.

7. The high-pressure liquid jet cutting system of claim 1 wherein the additive includes one or more of a polymer, a ceramic material, a metal, and/or a colloidal material.

8. The high-pressure liquid jet cutting system of claim 1 wherein the one or more processors are configured to determine a particle size and/or a brand of the abrasive based, at least in part, on the characteristic of the abrasive mixture.

9. The high-pressure liquid jet cutting system of claim 1 wherein the one or more processors are configured to determine a packing density, a hardness, and/or a friability, of the abrasive based, at least in part, on the characteristic of the abrasive mixture.

10. The high-pressure liquid jet cutting system of claim 1 wherein the one or more processors are configured to determine an age of the abrasive based, at least in part, on the characteristic of the abrasive mixture.

11. The high-pressure liquid jet cutting system of claim 1 wherein the characteristic of the abrasive mixture is a first characteristic detected at a first time, wherein the sensor is further configured to detect a second characteristic of the abrasive mixture associated with the additive at a second time, different than the first time, and wherein the one or more processors are configured to determine an age of the abrasive in the abrasive mixture based, at least in part, on the first characteristic of the abrasive mixture and the second characteristic of the abrasive mixture.

12. The high-pressure liquid jet cutting system of claim 11 wherein the first characteristic includes a first capacitance and wherein the second characteristic includes a second capacitance.

13. The high-pressure liquid jet cutting system of claim 1 wherein
the hopper is configured to receive an amount of the abrasive mixture,
the characteristic of the abrasive mixture is a first characteristic detected at a first time,
the sensor is further configured to detect a second characteristic of the abrasive mixture at a second time, different than the first time, and
the one or more processors are configured to determine an amount of spent abrasive material within the abrasive mixture based at least in part on the first and second characteristics of the abrasive mixture.

14. The high-pressure liquid jet cutting system of claim 13 wherein the first time is before the abrasive mixture is introduced into the high-pressure liquid jet, wherein the second time is after the abrasive mixture has been discharged from the cutting head in the high-pressure liquid jet.

15. The high-pressure liquid jet cutting system of claim 13 wherein the first characteristic includes a first capacitance and the second characteristic includes a second capacitance.

16. The high-pressure liquid jet cutting system of claim 1 wherein—
the characteristic of the abrasive mixture is a first characteristic detected at a first time,
the abrasive mixture is a first abrasive mixture,
the hopper is configured to receive a second abrasive mixture to mix with the first abrasive mixture at a second time,
the sensor is further configured to detect a second characteristic associated with mixing the first and second abrasive mixtures after the second time, and
the one or more processors are configured to determine an amount of the first abrasive mixture recycled into the second abrasive mixture based, at least in part, on the first characteristic and the second characteristic.

17. The high-pressure liquid jet cutting system of claim 1, further comprising one or more non-transitory, computer-readable media storing a data structure that relates the detected characteristic associated with the additive to the information about the abrasive, wherein the one or more processors are configured to query the data structure using the detected characteristic associated with the additive to determine the information about the abrasive.

18. The high-pressure liquid jet cutting system of claim 1 wherein the high-pressure liquid jet cutting system is a high-pressure water jet cutting system and the high-pressure liquid jet is a high-pressure water jet.

19. A method of operating a high-pressure liquid jet cutting system, the high-pressure liquid jet cutting system having a hopper and a cutting head, the method comprising:
receiving, at a first location, an abrasive mixture into the hopper, the abrasive mixture including abrasive and an additive;
causing the abrasive mixture to flow from the hopper toward the cutting head, wherein the cutting head is configured to introduce the abrasive mixture into a high-pressure liquid jet at a second location;
detecting, via one or more sensors positioned between the first location and the second location, a characteristic of the abrasive mixture, wherein the characteristic is associated with the additive; and
determining, via one or more processors operably coupled to the one or more sensors, information about the abrasive in the abrasive mixture based, at least in part, on the detected characteristic of the abrasive mixture.

20. The method of claim 19 wherein the hopper includes a sidewall that defines a chamber that contains the abrasive mixture, and wherein detecting, via the one or more sensors, a characteristic of the abrasive mixture includes detecting the characteristic through the sidewall of the hopper.

21. The method of claim 19 wherein the high-pressure liquid jet cutting system further includes a feed tube configured to convey the abrasive mixture from the hopper to the cutting head, and wherein detecting, via the one or more sensors, a characteristic of the abrasive mixture includes detecting the characteristic through a sidewall of the feed tube.

22. The method of claim 19 wherein the abrasive has a first value of the characteristic, wherein mixing the additive with the abrasive results in the abrasive mixture having a second value of the characteristic, and wherein detecting the characteristic via the one or more sensor includes detecting the second value of the characteristic of the abrasive mixture.

23. The method of claim 22 wherein detecting the characteristic includes detecting a capacitance associated with the additive.

24. The method of claim 22 wherein detecting the characteristic includes detecting a color associated with the additive.

25. The method of claim 22 wherein detecting the characteristic includes detecting a luminescence associated with the additive.

26. The method of claim 19 wherein the additive includes one or more of a polymer, a ceramic material, a metal, and/or a colloidal material, and wherein detecting the characteristic includes detecting a characteristic associated with one or more of the polymer, the ceramic material, the metal, and/or the colloidal material.

27. The method of claim 19 wherein determining the information includes determining a mesh size and/or a brand of the abrasive.

28. The method of claim 19 wherein determining the information includes determining a packing density, a hardness, and/or a friability of the abrasive.

29. The method of claim 19 wherein determining the information includes determining an age of the abrasive.

30. The method of claim 19 wherein the characteristic is a first characteristic obtained at a first time, and wherein the method further comprises:
detecting a second characteristic at a second time,
wherein determining the information includes determining an age of the abrasive in the abrasive mixture based, at least in part, on the first characteristic and the second characteristic.

31. The method of claim 30 wherein the first characteristic includes a first capacitance and wherein the second characteristic includes a second capacitance.

32. The method of claim 19 wherein receiving the abrasive mixture includes receiving an amount of the abrasive mixture, wherein detecting the characteristic includes detecting a first characteristic at a first time, and wherein the method further comprises:
detecting, via the one or more sensors, a second characteristic of the abrasive mixture associated with the additive at a second time after the first time,
wherein determining the information includes determining an amount of spent abrasive material within the abrasive mixture based, at least in part, on the first characteristic and the second characteristic.

33. The method of claim 32 wherein the first characteristic includes a first capacitance and the second characteristic includes a second capacitance.

34. The method of claim 19 wherein the abrasive mixture is a first abrasive mixture, wherein detecting the characteristic includes detecting a first characteristic at a first time, and wherein the method further comprises:
receiving, via the hopper and after the first time, a second abrasive mixture different than the first abrasive mixture to form a third abrasive mixture including the first abrasive mixture and the second abrasive mixture, and
detecting, via the one or more sensors, a second characteristic of the third abrasive mixture at a second time after receiving the second abrasive mixture,
wherein determining the information includes determining an amount of the first abrasive mixture recycled into the second abrasive mixture based at least in part on the first characteristic and the second characteristic.

35. The method of claim 19 wherein the high-pressure liquid jet cutting system includes one or more non-transitory, computer-readable media, and wherein determining the information includes querying, via the one or more processors, a data structure with the detected characteristic associated with the additive, the data structure stored in the one or more non-transitory, computer-readable media and relating the detected characteristic associated with the additive to the information about the abrasive.

36. The method of claim 19 wherein the high-pressure liquid jet cutting system is a high-pressure water jet cutting system and the high-pressure liquid jet is a high-pressure water jet.

37. The method of claim 19, further comprising changing the abrasive mixture and/or operation of one or more components of the high-pressure liquid jet cutting system based, at least in part, on the information.

38. The method of claim 37 wherein the information includes an age of the abrasive, and wherein changing the abrasive mixture includes adding newer and/or unused abrasive to the abrasive mixture.

39. The method of claim 37 wherein the abrasive in the abrasive mixture is a first abrasive, and wherein changing the abrasive mixture includes adding a second abrasive, different than the first abrasive, to the abrasive mixture.

40. The method of claim 37 wherein changing the operation of one or more components of the high-pressure liquid jet cutting system includes changing a rate of movement of the cutting head.

41. The method of claim 37 wherein the information includes an age of the abrasive, and wherein changing the operation of one or more components of the high-pressure liquid jet cutting system includes decreasing a rate of movement of the cutting head based, at least in part, on the age of the abrasive.

42. An abrasive mixture for use with a high-pressure liquid jet cutting system, the abrasive mixture comprising:
an abrasive material having a first characteristic and configured to combine with a liquid jet of the high-pressure liquid jet cutting system to process a workpiece; and
a sensor-detectable additive material mixed with the abrasive material and having a second characteristic.

43. The abrasive mixture of claim 42 wherein the first characteristic is a first capacitance and the second characteristic is a second capacitance.

44. The abrasive mixture of claim 42 wherein the first characteristic is a first color and the second characteristic is a second color.

45. The abrasive mixture of claim 42 wherein the second characteristic includes a luminescence.

46. The abrasive mixture of claim 42 wherein the abrasive material includes garnet.

47. The abrasive mixture of claim 42 wherein the additive material includes one or more of a polymer, a ceramic material, a metal, and/or a colloidal material.

48. The abrasive mixture of claim 42 wherein the additive material includes a dye or a coating applied to the abrasive material.

49. The abrasive mixture of claim 42 wherein the additive material is configured to withstand temperatures of up to 200° F.

50. The abrasive mixture of claim 42 wherein the additive material is configured to withstand pressures of up to 100,000 psi.
